(19) United States
(12) Patent Application Publication
(10) Pub. No.: US 2007/0209057 A1
(43) Pub. Date: Sep. 6, 2007

(54) WIRELESS DELIVERY OF BROADBAND CABLE SIGNALS

(75) Inventors: Jeffrey M. Musson, Windsor (CA); Elvino S. Sousa, Toronto (CA)

Correspondence Address: MILLER, CANFIELD, PADDOCK AND STONE;MARJORY G. BASILE, ESQ., 150 W. JEFFERSON, SUITE 2500, DETROIT, MI, 48226, US

(73) Assignee: Broadband Wizard Inc., Toronto (CA)

(21) Appl. No.: 11/680,956

(22) Filed: Mar. 1, 2007

Related U.S. Application Data
(60) Provisional application No. 60/778,635, filed on Mar. 1, 2006.

(51) Int. Cl. H04N 7/173

(52) U.S. Cl. 725/111; 725/63; 725/62

(57) ABSTRACT

A device for wireless, non-line-of-sight delivery of a signal from a coaxial cable to a transceiver at an end user device comprises a signal enhancement and prioritizing module which converts the signal into a wireless signal which comprises less data than the signal, and an antenna which broadcasts the wireless signal to at least one end user device transceiver, wherein the wireless signal has the capability to transfer data to the at least one end user transceiver at a rate of greater than 40 Mbit per second. In accordance with another aspect the signal enhancement and prioritizing module comprises an admission control unit module which processes variable bit rate information to determine whether a wireless signal may be transmitted to a particular client end user device, a dynamic scheduler module which processes variable bit rate information to determine when the wireless signal may be transmitted to a particular client user device, and a packet scheduling and retransmission module having forward error correction which is variable depending upon a condition of the wireless signal.

### RELATED APPLICATION

This application claims priority benefit of U.S. provisional patent application No. 60/778,635 filed on Mar. 1, 2006.

### FIELD OF THE INVENTION

This invention relates to improvements in broadband cable signal delivery, and more particularly to improvements in delivery of so-called triple play services—video, voice and data to end users such as televisions, personal computers, etc.

### BACKGROUND OF THE INVENTION

In residential areas, many dwellings receive television signals through community antenna television (CATV) systems, commonly referred to as cable television. Satellite transmissions from broadcasters are first received at a central location called the Head-end. At the head-end the signals are processed, encrypted and remodulated so they can be transmitted via fiber optic trunk cables to distribution nodes. Coaxial (‘coax’) trunk cables then route transmissions from these fiber nodes to taps or drop points at individual streets, with amplifiers placed at regular intervals to compensate for signal attenuation. A drop point can be housed in property-edge pedestals or in boxes mounted on utility poles or routed to a strip adjacent an apartment or condominium complex. At the drop point a coaxial cable is routed into people's homes (houses, condominiums, apartments, etc.) and directly to television sets, set-top boxes personal computers, etc. to provide a signal. The signal usually contains all programming available, and encryption software determines what video programs (i.e., which cannels) a given end user has paid to receive, and allows those to be viewed. The distance between the drop point or pedestal and the client end user devices which use the signal is sometimes referred to as the “last mile”. The signal so delivered can provide a user with cable TV (both video on demand and regular broadcasts) and, more recently it has been common to see internet access and voice information (for phone calls) also provided, the so-called “triple play” of telecommunications services. Video is the most intensive of these services in terms of the transmission bit rate requirement, and therefore the most technically challenging to deliver to customers.

The installation process of a dedicated coaxial cable line to a private residence usually involves burying the cable and drilling through walls to reach the client's receiver. It is labor-intensive and time-consuming, and relatively expensive. Moreover, the “last mile” is prone to damage from weather, construction mishaps, landscaping and gardening. It is estimated that a majority of cable service calls are related to problems in the last mile. It would be highly desirable to provide a wireless connection wherever possible. However known wireless approaches to service delivery of communication services to residences have their own limitations. For example, satellite transmissions are used where a signal is broadcast to a satellite dish mounted on the client's home, typically on or near the roof. From there the signal is routed into the house and to the client's devices. Satellite transmissions need a clear line of sight between the satellite and the satellite dish. The transmitted signal can be interfered with by rain, snow, freezing rain and sleet, etc. Moreover, and the quality of signal transmission is relatively uneven and unreliable, especially for video transmissions and the cost of the satellite dish is relatively expensive. Also the satellite system has a limited capacity per satellite and there is no return channel (i.e., no upstream broadcast) except when used in conjunction with a modem and a telephone network.

Cellular telephone networks can transmit signals over relatively long distances into people's homes, but video transmission to private residences is problematic due to the shortage of network capacity to transmit video as a result of the limited spectrum available to cellular network operators. Also available are wireless routers which are positioned in a client's house and broadcast signals received from a cable routed into the house wirelessly to client devices. Typically such routers work on the wireless LAN standard IEEE 802.11a/b/g. Such known routers only partially reduce the last mile problem since they require that a cable or telephone wire be run into the home. They are only a means to distribute the signal inside the home and not to bring it into the home from an outside access point. It would be desirable to reduce the problems associated with the last mile delivery of video transmissions.

### SUMMARY OF THE INVENTION

In accordance with a first aspect, a device for wireless, non-line-of-sight delivery of a signal from a coaxial cable to a transceiver at an end user device comprises a signal enhancement and prioritizing module which demodulates a signal on the cable, typically containing a number of TV signals, extracts a desired signals, re-encodes or transcodes the signal, and remodulates with the use of error correction codes, in order to transmit a wireless signal to and end user client in a residence. The signal enhancement and prioritizing module converts the signal into a wireless signal which comprises less data than the signal, and an antenna which broadcasts the wireless signal to at least one end user device transceiver, wherein the wireless signal has the capability to transfer data to the at least one end user transceiver at a high rates on the order of several tens of megabits per second. In accordance with another aspect the signal enhancement and prioritizing module comprises an admission control unit module which processes variable bit rate information to determine whether a wireless signal may be transmitted to a particular client end user device, a dynamic scheduler module which processes variable bit rate information to determine when the wireless signal may be transmitted to a particular client user device, and a packet scheduling and retransmission module having forward error correction which is variable depending upon a condition of the wireless signal.

From the foregoing disclosure and the following more detailed description of various preferred embodiments it will be apparent to those skilled in the art that the present invention provides a significant advance in the technology of broadband cable signal delivery. Particularly significant in this regard is the potential the invention affords for providing a high quality, low cost system for broadband cable signal delivery of cable television, internet access service and voice over internet services. Additional features and advantages of various preferred embodiments will be better understood in view of the detailed description provided below.

### BRIEF DESCRIPTION OF THE DRAWINGS

FIG. 1 is a plan illustration of a system for wireless “last mile” delivery of broadband cable signals in accordance with a preferred embodiment.

FIG. 2 is a block diagram of a system for wireless delivery of broadband cable signals in accordance with a preferred embodiment, showing conversion of a signal input at a coaxial cable and wireless transmission from antennae to client devices equipped to receive wireless signals.

FIG. 3 is a block diagram of the end user or client devices which receive the wirelessly transmitted signal and convert it to a format interpretable by end user devices such as personal computers and televisions, etc.

FIG. 4 is a block diagram expanding on the wireless module in FIG. 2, showing various modules that process and prioritize the incoming signal prior to wireless transmission.

It should be understood that the appended drawings are not necessarily to scale, do not necessarily include all the system components required for an actual implementation, and present a somewhat simplified representation of various preferred features illustrative of the basic principles of the invention. The specific design features of the system for wireless delivery of broadband cable signals as disclosed here, including, for example, the specific dimensions of the wireless access point, will be determined in part by the particular intended application and use environment. Certain features of the illustrated embodiments have been enlarged or distorted relative to others to improve visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the system for wireless delivery of broadband cable signals disclosed here. The following detailed discussion of various alternative and preferred features and embodiments will illustrate the general principles of the invention with reference to wireless delivery of broadband cable signals to a person's home. Other embodiments suitable for other applications will be apparent to those skilled in the art given the benefit of this disclosure.

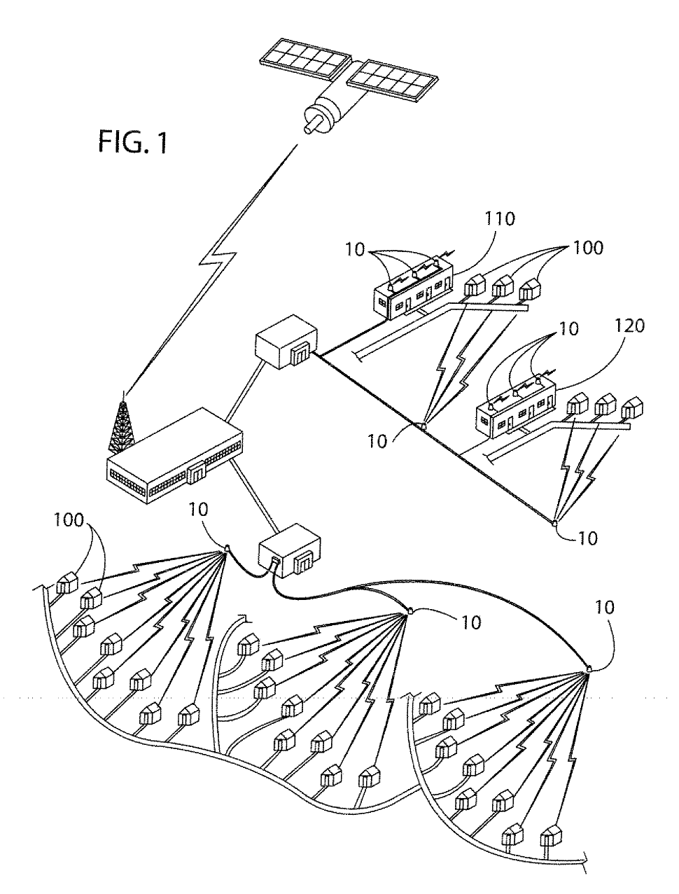

Referring now to the drawings, FIG. 1 shows a representative setup where video data, internet access data and voice data may be transmitted to end users, and the last mile, that is, the connection into the house, is transmitted wirelessly. Generally transmissions from content providers are first received at a central location called the Head-end. At the head-end the signals are processed, encrypted and remodulated so they can be transmitted via fiber optic trunk cables to distribution nodes. Coaxial (‘coax’) trunk cables then route transmissions from these fiber nodes to taps or drop points at individual streets, with amplifiers placed at regular intervals to compensate for signal attenuation. A drop point can be housed in property-edge pedestals or in boxes mounted on utility poles or routed to a strip adjacent an apartment or condominium complex. Signals can be transmitted both downstream (to the end user) and upstream (from the end user). The place where such upstream and downstream signals are transmitted wirelessly is sometimes referred to as the access point. Heretofore coaxial cables were generally the preferred upstream and downstream signal medium into people's homes and into connection with end user devices such as televisions (for cable TV) personal computers or laptops (for internet access), etc. The access point is preferably located up to several hundred feet from a home 100, apartments 110 or condominiums 120. Several access points will provide coverage to a residential area. Each access point defines a cell and covers the homes contained in that cell. Current cable transmission of a signal to homes carries all TV signals available for subscription. These signals occupy a frequency band in the cable of approximately 800 MHz bandwidth. As a result of the limited radio spectrum the disclosed system transmits selectively on the channel requested by the user. Advantageously, the device at the access point extracts the requested channel from the cable to transmit a wireless signal to the home. Also advantageous is that the wireless signal may be broadcast on an unlicensed frequency.

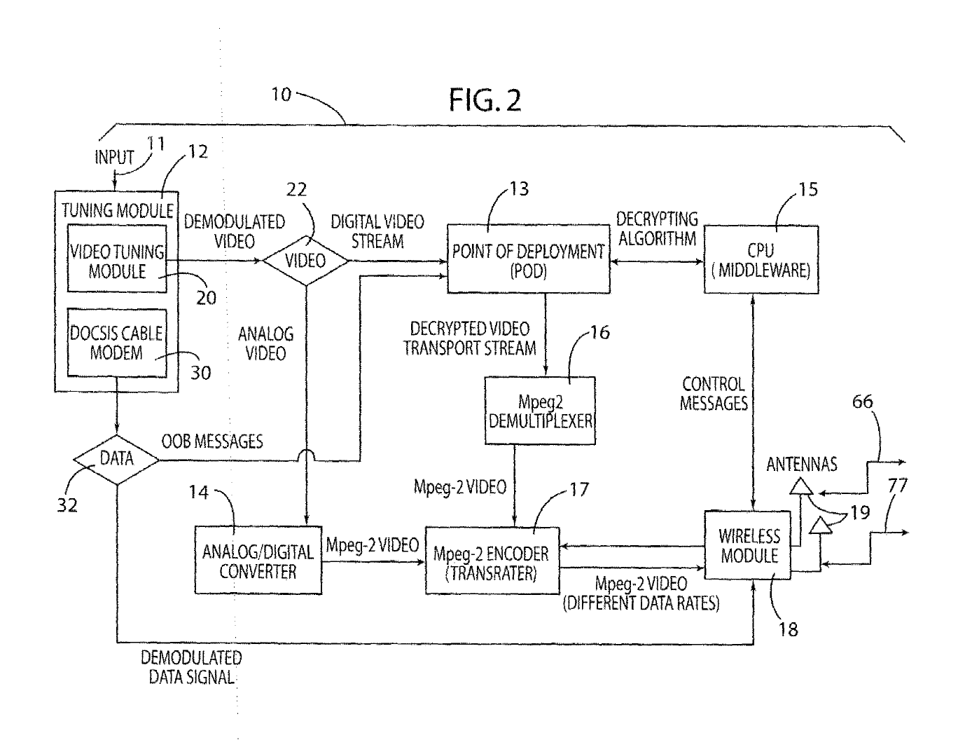

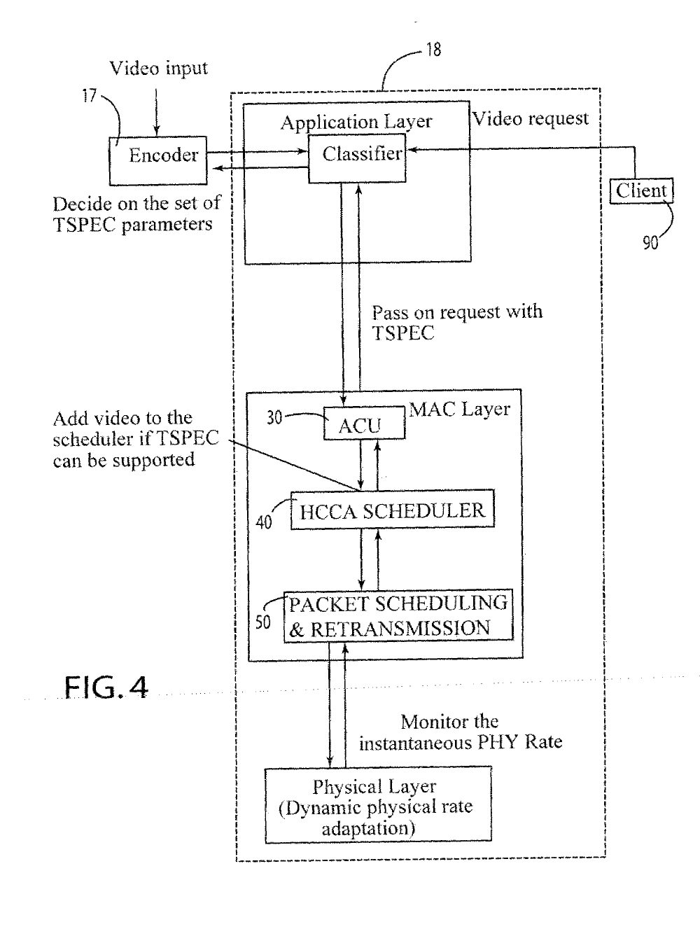

FIG. 2 shows a block diagram of the device 10 for wireless transmission of data comprising a series of modules. The modules may include hardware circuitry, single or multi-processor circuits, memory circuits, software program modules and objects, firmware, and combinations thereof, as desired by the architect of the device and as appropriate for particular implementations of various preferred embodiments. These modules combine to form a signal enhancement and prioritizing module which demodulates a signal on the cable, typically containing a number of TV signals, extracts a desired signals, re-encodes or transcodes the signal, and remodulates with the use of error correction codes, in order to transmit a wireless signal to and end user client in a residence. The device 10 comprises is preferably cross layered, having an application layer, a medium access control (MAC) layer and a physical layer. Multiple digital tuners are provided which decode, de-encrypt and de-multiplex a full 864-MHz cable bandwidth into discrete transport streams (typically of about 6 MHz) in order to deliver channel content for preferably at least 8 end user devices on an ‘on-demand’ basis. The device is also equipped with a wireless modem that most preferably transmits using the IEEE 802.11n protocol developed for wireless local area networks. Wireless transmissions are sent and received between pedestal antenna 19 (in FIG. 2) and multiple end user antennas 89 (shown in FIG. 4) at a rate of at least up to 40 Mbits/second, and most preferably up to 200 Mbits/second. For example, a standard definition TV broadcast requires about 4 Mbit/second. If 8 end users are watching standard definition TV then only 32 Mbit/s would be used. Advantageously, the device can support many more end user devices before the full allotment of 200 Mbits/second is used. Servicing multiple users from one access point is highly advantageous in that it allows access points to be spaced further apart, reducing the need for access point pedestals.

A signal 11 from the coaxial cable is sent to a tuning module 12 comprising a video tuning module 20 for video data and a Data Over Cable Service Interface Specification (“Docsis”) cable modem 30 for internet access data. Docsis defines the communications and operation support interface requirements for a data 32 over cable system and permits the addition of high-speed data transfer to an existing cable TV system. The video tuning module 20 tunes to a specific frequency, demodulates the signal on that frequency and generally performs small modifications to the incoming signal. The incoming signal received by the tuning module can be analog video, which contains only one TV channel, digital video transport stream, which can contain up to 6 TV channels, internet data, and out of band (“OOB”) messages which are the exchange of signal control information in a separate band of the data, or on an entirely separate, dedicated channel. Video data 22 in analog form may be passed to an Analog to Digital Converter 14 and converted to a digital signal and passed to the encoder 17 directly since analog channels are usually not encrypted. The demodulated signal is passed to the Point of Deployment (POD) module 13.

The Point of Deployment module controls the decryption of encrypted signals received from the cable. Typically the POD includes program denial functions that allow an operator of the data transmission service (i.e., the cable operator) to sell premium services. Without the POD module the host cannot receive anything but a basic unencrypted service. The POD module decrypts the digital stream coming from the tuning module 12 and it passes the decrypted signal to the MPEG-2 Demultiplexer 16, a module that takes a single input and selects one of many data-output-lines and connects the single input to the selected output line. For example, the input content is a stream that contains up to 6 TV channels. This module demultiplexes the combined channels, chooses one requested by the user and passes this video channel to the encoder 17. The POD module 13 runs decryption algorithms using a central processing unit (CPU) 15. The CPU host is a microprocessor that controls all the functions of the device and its user interfaces. The CPU may optionally also house some applications.

Mpeg-2 Encoder 17 is preferably a scalable encoder which divides the video stream into 2 substreams, a base substream and at least one enhancement substream. The base layer is needed for a minimum viewing experience while the enhancement on is used for adding quality to video transmissions if more bandwidth is available. These sub-streams are handed over to an hybrid coordinator function controlled channel access (“HCCA”) scheduler of the MAC layer as different streams having their own average data rates, delay bounds and priority. The base layer will have a higher priority than any enhancement layers. The mpeg-2 encoder 17 efficiently splits the video into different streams by taking into account bit allocation for transmission, delay constraints of each frame and the importance of each frame.

A wireless module 18, shown in greater detail in FIG. 4 contains the MAC layer, physical (PHY) layer and radiofrequency (RF) front end that package the streams into a wireless signal for transmission to the clients or end user devices. It can send and receive messages from the clients' end user devices. The wireless module has the following MAC layer components as part of the cross layer model: an Admission Control Unit (ACU) 30; an HCCA Dynamic Scheduler 40; and a Packet Retransmission and Forward Error Correction (FEC) 50. These modules greatly enhance the quality of the wireless signal received by any particular client.

The ACU module 30 receives service requests from different clients 90 and based on the requirements of the clients and on the resources available (i.e. instantaneous data rate from the PHY layer) decides if it can support the request or not. That is, the ACU module determines whether a wireless signal may be transmitted to a particular client end user device. For example, if bandwidth constriction limitations are high then the ACU may allow only the base substream to be transmitted. The encoder 17 is designed for constant bit rate data only. The ACU module algorithm is designed to consider and process variable bit rate (VBR) stream signals such as video to decide whether a given request can be supported and the wireless signal transmitted to the end user device. The main job of the ACU algorithm is to receive service requests from different clients and to decide based on the requirements and on the resources available if it can support the request or not. When a client requests a service from the ACU, the application layer should summarize the service's requirements in a set of variables known as the TSPEC (Traffic SPECification). The following variables may be included in the TSPEC: average data rate, maximum data rate, maximum burst size, average packet size, maximum packet size, maximum SI (Service Interval) and minimum physical rate. The Service Interval (SI) is a constant amount of time which repeats periodically.

In the ACU module, the available time in an SI is monitored and an average of the available time is computed. As an example of the available time in the SI, if the SI is 1 ms, and within this 1 ms interval there are scheduled video transmissions totaling 0.6 ms, the available time is the unused time within the SI—in this example 0.4 ms. The average available time is a weighted average between its previous value and the most recent monitored available SI time. When a new stream asks for services from the ACU the following algorithm should be followed to decide if it should be accepted or not:

Step 1. Check the minimum PHY rate required by the stream. If it is greater than the instantaneous physical rate at that point move to step 2. If not then refuse the stream and prevent transmission to the client's end user device.

Step 2. Calculate a transmission opportunity (“TXOP”) required for a new client user device or station based on the average data rate and instantaneous physical rate (not the minimum PHY rate of the TSPEC). Calculate a “protection” coefficient from the peak rate and maximum burst size. This coefficient should be multiplied with the TXOP previously calculated and then compared with the average available time in the SI. If this new stream can be fitted in it should be accepted, otherwise it should be refused. For example, the available time in the SI is 0.4 ms, and a new station requires service from this AP. The new station requires about 0.25 ms worth of TXOP. The Protection Coefficient is calculated using the peak transmission rate of this station. It is multiplied with the TXOP as a means of protection for this station for those cases when the station reaches the peak rate.

Once a stream of data has been accepted by the ACU, it is then passed on to the Dynamic Scheduler module 40 to be scheduled in a time slot known as the Transmission Opportunity, defined as part of 802.11. The known IEEE HCCA reference scheduler algorithm does not support VBR streams. In accordance with a highly advantageous feature, this dynamic scheduler 40 takes into account variable bit rate applications of the signal, such as video, and schedules when the streams in the TXOP along with data and audio packets are to be transmitted as the wireless signal to the end user devices. A dynamic scheduler algorithm may have, for example, the following steps:

Step 1. Determine the SI as the minimum MAX SI of all TSPECS of the admitted streams. The SI is preferably constant as long as the end users remain the same.

Step 2. Calculate the transmission opportunity (TXOP) in the beginning of each SI of the admitted clients end user devices using the submitted average data rate and the instantaneous PHY rate. This is different from the ACU where the minimum submitted PHY rate was used. This creates an initially assigned TXOP and may be considered as a guarantee for each particular downstream transmission or wireless signal.

Step 3. After finishing with all the initial assigned TXOPs the dynamic scheduler assigns more TXOP time for the stations or client end users that require more time. The time it takes to send a buffer for each station is calculated and divided by the remaining time in the SI proportionally. The base layer streams for each end user device will be served first and all the TXOP times are going to be prioritized in terms of delay, with the devices having a shorter delay scheduled first. If there is still time left within the SI the same process gets applied to the enhancement layer streams.

A hybrid ARQ (Automatic Request) and forward error correction FEC module 60 is used at the MAC layer to account for channel errors and packet losses while reducing overhead and unnecessary retransmissions. ARQ alone is not sufficient for multimedia transmission due to the unbounded delay. On the other hand, FEC (Forward Error Correction), if used alone, incurs a lot of overhead (as it needs to deal with the worst-case channel conditions). In accordance with a highly advantageous feature, a Packet retransmission and forward error correction (FEC) module 60 is provided which acts to protect the transmitted data against channel errors. That is, the wireless signal sent the client end user devices relies initially on forward error correction, and the rate of FEC is adaptable to varying channel broadcast conditions, i.e., to the conditions of the wireless signal sent from the access point and to the end user device. Forward error correction is a system of error control for data transmission, whereby the sender adds redundant data to its messages, which allows the receiver to detect and correct errors (within some bound) without the need to ask the sender for additional data. The advantage of forward error correction is that retransmission of data can often be avoided, at the cost of higher bandwidth requirements. FEC is implemented here preferably using the known Reed-Solomon (RS) codes which are known to have good error correction characteristics. Both a MAC header and a MAC message preferably are encoded. For the header a different type of coding (other than RS) may be used.

At the end user devices of the several clients, first an attempt is made to correct the errors at the MAC layer using the FEC and if the decoding is successful sends an ACK (acknowledgement) upstream signal to the access point. On the other hand, when errors are not correctable, a NAK (no acknowledgement) may be sent back to the access point. At the access point, upon receiving a NAK or if an ACK-timeout expires, the corresponding packet is scheduled for retransmission after all TXOPs are over. Retransmission will be performed only if the retransmission limit for that packet is not reached yet. In the initial implementation fixed retransmission limits preferably are used for different video layers (e.g., 3 for the base and 1 for enhancement layers).

The rate of the FEC is adaptable or variable in varying channel conditions to accommodate different environments/interference levels. There are two ways to implement the FEC rate adaptation: end user-based or access point-based. For end user based FEC rate adaptation, when the wireless signal is being set up for the first time a default rate or transfer can be used or a desired rate can be specified in the TSPEC by the end user. Afterwards, the end user monitors the signal strength of the access point at periodic time intervals and selects one of several possible FEC rates. Then, this selection is fed back to the access point by piggybacking it on an ACK. For access point-based FEC rate adaptation, either the packet loss rate (PLR) or the physical rate for each downstream signal is monitored and if the PLR (PHY rate) goes above (or below) a certain threshold, a lower- (or higher-) rate FEC code is used and vice versa. The adaptation frequency of FEC depends on the rate of variations in the channel condition which in turn depends on degree of mobility, number of neighboring access points, if any, etc. Updating RS code once in every few seconds is sufficient for relatively static environments.

When using retransmissions the frames within the video stream should be given different retransmission limits based on the priority of that frame. Retransmission limits are based on a Group of Pictures (GOP) basis. That is each GOP, which has a constant number of frames and is periodic, has a fixed number of retransmission. Since the frames at the end of the GOP depend on the preceding frames of the GOP, the retransmission algorithm should give a higher priority to the frames at the beginning the GOP. That is, the algorithm reschedules retransmissions for the frames in the GOP as they come in order from the beginning to the end of the GOP till the maximum number of retransmissions for the GOP is reached.

The signal transmitted over cable is reduced to the wireless signal based both on a limiting instruction from the signal enhancement and prioritizing modules and upon a request or demand from the end user device. For example, an end user may want to watch a particular TV channel, and sends an upstream request, at the same time, wireless signal conditions are such that only the base stream can be transmitted at that time. The device transmits the base stream of the desired channel until the conditions have changed to permit broadcast of the enhanced streams.

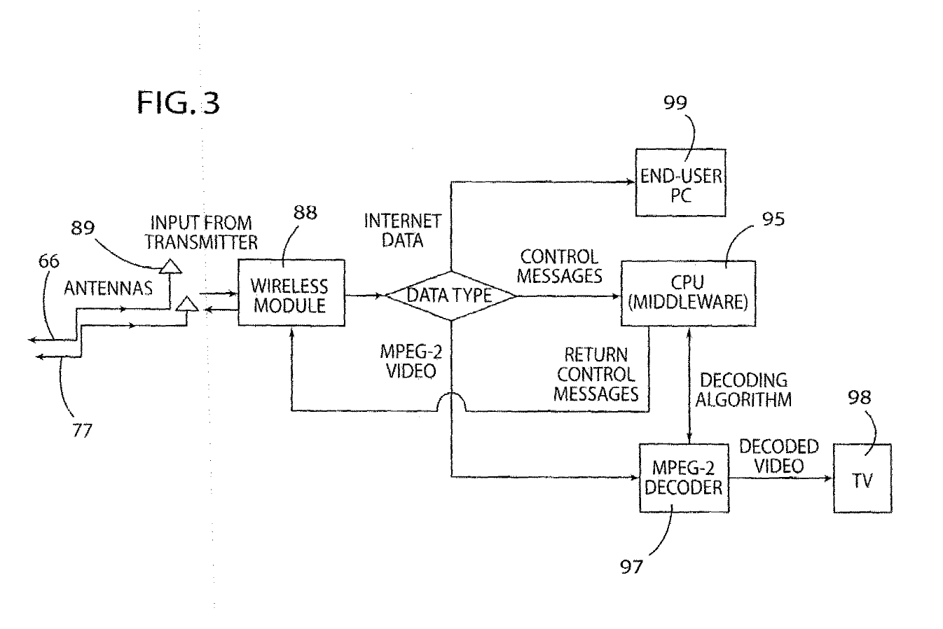

FIG. 3 shows a client or end-user or terminal station. This station would typically reside in the home of a user and replace a service subscriber's conventional set-top cable TV box. Most preferably the end user station is incorporated into the devices which display the data transmitted by the wireless signal. Typically multiple homes may be serviced by the same access point, and multiple end user devices (such as personal computer 99 or television 98) may be serviced in multiple homes. The client would relay the information requested by the end-user to the access point, via antenna 89, decode the stream sent by the AP and display it according to the service guarantee of that request. Wireless signals 66, 77 are received by antenna 89 and converted into mpeg-2 video data or internet data by client wireless module 88. The wireless module is a transceiver in that it cooperates with a CPU 95 to transmit upstream messages useful for the signal enhancement and prioritizing module at the access point.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A device for wireless, non-line-of-sight delivery of a signal from a coaxial cable to a transceiver at an end user device comprising, in combination:
a signal enhancement and prioritizing module which converts the signal into a wireless signal which comprises less data than the signal, and
an antenna which broadcasts the wireless signal to at least one end user device transceiver, wherein the wireless signal has the capability to transfer data to the at least one end user transceiver at a rate of greater than 40 Mbit per second.

2. The device of claim 1 wherein the wireless signal has the capability to transfer data to multiple end user transceivers at a rate of greater than 150 Mbit per second.

3. The device of claim 1 wherein the end user device comprises one of a personal computer, a laptop and a television.

4. The device of claim 1 wherein the wireless signal is broadcast on an unlicensed frequency.

5. The device of claim 1 wherein the signal is not broadcast to at least one end user device transceiver.

6. The device of claim 1 wherein the signal enhancement and prioritizing module comprises an encoder which splits the signal into a base stream and at least one enhancement stream.

7. The device of claim 1 wherein the signal is reduced to the wireless signal based on a demand from the end user device.

8. The device of claim 1 wherein the signal is reduced to the wireless signal based on a limiting instruction from the signal enhancement and prioritizing module.

9. The device of claim 1 further comprising a tuning module comprising a video tuning module for tuning video data of the signal and a Docsis cable modem for internet access data.

10. The device of claim 1 further comprising an analog to digital converter which converts an analog portion of the signal to a digital signal.

11. The device of claim 1 wherein the signal comprises video data, internet access data and voice data.

12. The device of claim 1 further comprising a point of deployment module which decrypts encrypted portions of the signal.

13. A device for wireless, non-line-of-sight delivery of a signal from a coaxial cable to a transceiver at an end user device comprising, in combination:
a signal enhancement and prioritizing module which converts the signal into a wireless signal which comprises less data than the signal, wherein the signal enhancement and prioritizing module comprises an admission control unit module which processes variable bit rate information to determine whether the wireless signal may be transmitted to a particular client user device; and
an antenna which broadcasts the wireless signal to at least one end user device transceiver.

14. A device for wireless, non-line-of-sight delivery of a signal from a coaxial cable to a transceiver at an end user device comprising, in combination:
a signal enhancement and prioritizing module which converts the signal into a wireless signal which comprises less data than the signal, comprising a dynamic scheduler which processes variable bit rate information determines when the wireless signal may be transmitted to a particular client user device; and
an antenna which broadcasts the wireless signal to at least one end user device transceiver.

15. A device for wireless, non-line-of-sight delivery of a signal from a coaxial cable to a transceiver at an end user device comprising, in combination:
a signal enhancement and prioritizing module which converts the signal into a wireless signal which comprises less data than the signal, wherein the signal enhancement and prioritizing module comprises forward error correction which is variable depending upon a condition of the wireless signal; and
an antenna which broadcasts the wireless signal to at least one end user device transceiver.

16. The device of claim 15 wherein the end user device monitors the wireless signal strength at periodic time intervals and selects one of several possible FEC rates.
